(19) United States
(12) Patent Application Publication
(10) Pub. No.: US 2010/0192465 A1
(43) Pub. Date: Aug. 5, 2010

(54) COMPONENT FOR PRODUCING A SECTIONAL DOOR PANEL, SHELL FOR SUCH A COMPONENT, REINFORCEMENT STRUT FOR SUCH A COMPONENT, SECTIONAL DOOR PANEL HAVING SUCH A COMPONENT, AND SECTIONAL DOOR HAVING A CORRESPONDING SECTIONAL DOOR PANEL

(75) Inventors: Thomas J. Hörmann, St. Wendel (DE); Michael Brinkmann, Halle (DE)

Correspondence Address: Schwabe Williamson & Wyatt;PACWEST CENTER, SUITE 1900, 1211 SW FIFTH AVENUE, PORTLAND, OR, 97204, US

(73) Assignee: HORMANN KG BROCKHAGEN, Steinhagen (DE)

(21) Appl. No.: 12/598,194

(22) PCT Filed: May 3, 2007
(86) PCT No.: PCT/EP07/03918

§ 371 Date: Mar. 5, 2010

(51) Int. Cl. E06B 3/48

(52) U.S. Cl. 49/73.1

(57) ABSTRACT

A structural element for the fabrication of a panel of a sectional door, which is movable between a closed and an open position along a predetermined pathway. The sectional door possesses a shell, generally of metal, having two mutually parallel sides, bent back on themselves, thus essentially creating structural elements aligned somewhat perpendicularly to the predetermined pathway. When in the closed position, the shell is characterized by forming an outer door surface which is external to the space to be closed, and forming an internal door surface opposed thereto.

The invention concerns a structural element for producing a panel of a sectional door, which is movable between a closed and an open position along a predetermined pathway. The sectional door panel possesses a shell, generally of metal, having two mutually parallel sides, bent back on themselves, thus essentially creating movable structural elements positioned somewhat perpendicularly to the predetermined pathway. When in the closed position, the shell is characterized by having an outer door surface which is external to the space to be closed, and having an internal door surface opposed thereto, In this arrangement, a side located structural element of the shell possesses a designed fastening area, this advantageously being provided with a clearance from the inner surface and running approximately parallel thereto as well as serving for the fastening of at least one structural element for the securement of hinges. The hinges and their securing flanges are linearly repeated across and between the door panels.

Sectional doors having a plurality of door panels with structural elements, which are in an articulated connection with one another, and possess mutually parallel pivotal axes are frequently installed in garages, and industrial buildings for purposes of restricting unauthorized driving through the buildings. In both garages and industrial buildings, the door panel is normally in the closed position and thus in a vertical plane. When open, the door panel seats itself in an overhead, horizontal plane. For the guidance of door panel motion, between the closed and the open position are provided continuous guide rails, usually located on both sides of the door panel and parallel to each other. These rails are, for the most part, approximately in straight lines and parallel to the door panel sides when in the vertical section of a closed door. When the door panel is open and in the said overhead horizontal position, the rails run likewise horizontally and are still parallel to the sides of the door panel. To join the vertical and the horizontal rail sections, a curved section of rail is interposed therebetween. To enable door panel movement along the curved section, the structural elements which form the door panel are bound together approximately perpendicularly to the bending axes of the guide rails and are themselves mutually articulated.

The structural elements which form the door panel are intended, in the first place, to provide a secure, non-invasive closure of a passageway, that is to say to assure a sufficient blocking of unwanted penetration therethrough. Secondly, these structural elements are to exhibit the least possible weight, in order that the mounting thereof and operations of the sectional doors can be carried out without difficulty. In the case of conventional sectional door construction, as is disclosed in EP-A-304 642 and EP-A-370 376, the structural elements involved in door panel construction are to be made of cold rolled sheet metal, whereby the sheet thickness is to be 0.4 mm or less.

In the case of simple sectional doors, it is possible that upon manual pivoting of an individual door panel, an open fissure may develop during door operation. This fissure can allow the entry of fingers. In the course of normal door panel operation, this said open fissure can close, with a resulting crushing of the fingers. In the documentation describing sectional panel doors, this problem is solved, in that the metal shells forming the structural elements possess, in a longitudinal direction, a projecting part, running transversely to the designed track and parallel to the bending axes. This said part runs along the structural elements extending along the upper part of the door panel when the door is in the closed position. The advantage of this, is that in course of a pivotal movement, within the lower rim of a neighboring panel, a recess is located into which the said projection can enter. In this way, avoidance of finger damage in the bending axis is achieved and the formation of the described fissure cannot occur.

Even though the structural element receives a stabilized safety condition due to the said finger protective measure, an allowance for total safety stabilization assuring a disturbance-free operation has not yet been attained. Consequently, in the case of the so-called single-shell structural elements, reinforcement struts are installed on the inner surfaces of the shells, running at right angles to the side elements. To achieve a safety centered purpose, the side structure normally possesses a fastening area which also permits the installation of successive structural elements which introduce mutually connected hinges. On the said fastening area the reinforcement struts are generally secured by riveting. When so installed, the reinforcement struts also serve for stabilization of hinge flanges, making use of the screws available in the said fastening area. The manufacture of single-shell structural elements is associated with high costs.

In many installations, sectional doors assure not only the closure an invasive passageway, but also provide thermal and/or acoustic insulation in the internally protected panel cavities from disturbances in the surrounding environment. To achieve this protection, in the said documentation describing the state of the technology, structural elements have been proposed, wherein, between one of the outer boundary metallic shells of the door panel and one of the inner metallic boundary metallic shells, a packing of a foamed material is inserted. Such foamed material is commercially available, and is particularly advantageous when the insulation is a self foaming substance such as, for example, polyurethane. This material can be injected into the outer shell, which shell will then also serve, with the aid of the inner shell, as a limiting boundary for the applied insulation. Thus the said cavity is safely filled, since the inner shell, with its own reverse folded sides, is securely attached to the outer shell. The self foaming material fills the entire inside space of the double shelled door panel. Corresponding shell construction may be seen in EP-A-304 642 and EP-A-370 376.

The content of the disclosure of these named publications is herewith acknowledged and expressly accepted in this description in regard to the type of structural elements for the production of sectional door panels, in particular in regard to the manner of finger protective measures by treatments of involved structural elements.

Manufacture and mounting of the here described, conventional double shell structural elements are carried out only at excessive cost. For the solution of mounting problems, in DE 10 2006 012 224 a design of a structural element is proposed, wherein insulation pads are laid against an interior surface of the shell. In this case, one side of the insulation pad is at least form-fit into the side structure of the shell.

The disclosure in DE 10 2006 012 224, particularly in regard to the design of single-shell structural elements for the manufacture of sectional door panels is herewith recognized and considered in this description. Experience has indicated however, that the structural elements described in the said publication can be quickly damaged.

In consideration of these problems in the state of the technology, the invention has the purpose of making available a structural element for the production of a sectional door panel, which invented structural element is to enable exceptional simplicity and mounting of sectional door panels, whereby optionally, a desired insulation activity can be assured, which does not demand any exceptional labor or cost expense during mounting.

In accord with the invention, this purpose is achieved by means of developing known structural elements, which achievement, essentially, is therein characterized, in that the fastening area of the shell constitutes approximately circularly curved recessing, and a pre-fabricated positioning aid for screws or rivets to secure the hinges. his improvement is to also serve for the installation of a reinforcement strut which extends itself approximately vertically to the side structure, advantageously being set on an inner surface, with an end surface embedded in at least one side structural element and/or encapsulating the said structural element.

This invention bases itself on the knowledge, that the manufacture of single-shell structural elements can be considerably simplified, in that riveting can be eliminated in affixing the reinforcement strut onto the fastening areas of the shell. This economic measure can be carried out if, in a premounting stage the reinforcement strut can be installed without additional fastening means. This is done with the help of appropriate positioning in the fastening area by means of form-fitting plus simultaneous embedment of the reinforcement struts. The said positioning is carried out by a positioning aid, to especially assure the placement of the reinforcement strut at a predetermined location in the longitudinal direction of the side structure. A final securement of the reinforcing strut onto the shell can, under these circumstance, be extended with the aid of screws to affix a row of successive flanges which secure the hinges. These screws would holdingly penetrate through to the reinforcement strut. In this way, the positioning aid can be simultaneously designed, so that, screw positioning is executed in such a manner, that the screws also penetrate the fastening area of the shell as well as the preassembled reinforcement strut.

Furthermore, the manufacture of the double shelled door panels can be made easier, in accord with the invention, because by a provided positioning aid, the placement of successively installed structural elements for the mutually bound hinges can also be improved.

In both the single shell as well as the double shell structural element, it is possible that the positioning aid, can be installed in the course of the structural support of the advantageously cold rolled metal sheet. An additional work-step which would include boring, stamping or cutting holes in the fastening areas of the shell and at locations specified by positioning design becomes, with the described advantage, unnecessary.

For the assurance of an exactly positioned, premounted shell and/or with consideration that the hinge mounting flanges are customarily set with two, three or more screws onto the fastening area of the shell, it is advisable, that the positioning aid, in accord with the invention, be made of a group of at least two, three or more adjacently aligned structural elements arranged along the longitudinal length of the side structure, whereby the said structural elements would be complementary to a group, to a hinge, and/or to a reinforcement strut.

The structural elements of a group of the positional aids could be factory installed in both the screw positions which hold the hinge flanges, as well as in the predetermined location of the reinforcement struts. In this way, it becomes possible to consider the various purposes of the structural elements when supplying them in suitably corresponding shapes. It has shown itself as advantageous if at least two structural elements of a group, such as those used for the positioning of the reinforcement struts, and/or those determining the positioning of the structural element held by screws, which are installed transversely to the longitudinal extent of sectional plane of the side structure, are of identical shape. In such a case, the said elements could be considered as interchangeable. Further advantages can be found, if the different tasks of structural elements can be reflected in different shapes of the said structural elements, that is to say, having different structural thickness and/or diameters. If this is the case, then it is possible that the structural elements installed during the prefabrication of the reinforcing struts can exhibit a greater thickness and/or diameter than is the case for the structural elements which were employed for the positional determination of the fastening screws. Thus, due to the selection of structural sizes on that basis, it is possible that a (very small) material weakening may be caused. On this account, for safety reasons, a fully satisfactory installation of the hinges is advantageous, if the element installed for the positional determination of the screw borings has a thickness less than ordinarily desired in order to assure a secure seating of the screws in the structural elements.

Considering a possibly insufficient width of the hinge flanges along the longitudinal extent of the side structure or the insufficient dimensioning of the reinforcement struts, along the same stretch, the positioning elements of a group in that same stretch, have been set at a length of 80 mm or less, better at 60 mm or less and especially advantageously set at 40 mm.

In addition, considering the fact, that two, three or more hinges and/or reinforcement struts in the length of the side structure are placed next to one another, within the boundaries of the invention, recommendation may be made that at least one structural element in the longitudinal side structure, be equipped with two, three or more groups of additional structural elements, whereby, individual structural elements in adjacently arranged series are spaced from one another within the conventional specifications for a separating distance between individual hinges and/or reinforcing struts. This specification calls for a spacing of 300 mm or more, preferably 400 mm or more, and especially recommended, a spacing of 600 mm or more.

The structural elements for site mounting, in accord with the invention, which elements comprise the sectional panels, can be allowably simplified, if structural elements having the same cross-section, which lie within different groups in the longitudinal extent of the side structure, are separated by equal distances from one another. The reason for this is that the installation of identical reinforcement struts and/or hinges is enabled to take place at different places on the structural element.

A stabilization of the fastening area and the entire side structure of the shell can be attained if the said fastening area, which runs parallel to the inner surface, extends itself into a bending line, which is somewhat perpendicular to the outer surface and is parallel to the side structure and runs in a direction away from the said fastening area, toward the inner surface. This bending line further extends itself advantageously, parallel to the longitudinal axis of the side structure and strengthens itself in a backfold, to make a reinforced area. In this arrangement, that side of the stabilizing structural element, which is proximal to the inner surface of the stabilization structure, that is to say, proximal within a given distance of separation to the bending line. A distance away from the inner surface is to approximate 15 mm or more, preferably 25 mm of more, between the stabilization area and the inner surface of the shell, it is possible to fill the resulting intershell cavity with a packed material, this being, for example, loose or block-form insulation. Also one or more reinforcement struts could advantageously be installed therein.

To attain a secure, desired placement of the above said reinforcement strut in relation to the shell, in which it may be placed, experience has shown that an advantage arises if at least one reinforcement strut is provided with a latching device. This latching device would be advantageously located on that inner surface of the shell which lies remote from the boundary surface of the fastening area and comprises, in part, a punched or incised receiving opening. The opening would be complementary to a structural protrusion or latch engagement on the positioning aid. In the latching function, with this arrangement, it becomes possible for at least one of the latch engagement elements, when in the fully mounted condition, to be at least partially engaged in the said receiving opening, that is received in a structural element of the fastening area. This engagement is especially in the form of a projection holdingly entering an opening, which opening is in a structural element. Thus the at least one structural element of the shell, which served for the positioning of fastening screws, in this operation, is itself positioned by a recess in the reinforcement strut while a preselected structural element of shell provides the said holding projection which is complementary to the said recess.

The action of the reinforcement can be increased, if at least one reinforcement strut possesses at least one connection surface located on either an inner or outer surface of the shell, and which is advantageously retentively secured by shape-fit means with the inner and outer surfaces, or, alternately affixed thereto by adherent means. By means of the said adherence it becomes possible, moreover, to attain in addition a sound barrier, even if the thickness of the layer of adherent matter (or glue) between the fastening area on the one hand and the inner/outer surface on the other is no more than 0.5 mm or less.

A particularly effective reinforcement of the door panel structure can be achieved, if at least one reinforcement strut is folded over into a U-shape, thus forming two separate sheet metal legs and a cross-connector which represents the fold. The above said engagement (latch) apparatus is advantageously placed on at least one of sides thereof, which side overlaps, or underlays the shell. As a result, at least one fastening area is to be found on at least one reinforcing surface on one U-shape side remote from the other leg but parallel thereto. An additional, but further improved stabilization function is gained in a compact design of the reinforcement strut which allows, that if on each outer leg of the U-shape a fastening area is formed, whereby the fastening area, advantageously, extends itself into the inner space between the two legs of the U-shaped reinforcement strut and is bent in this space in such a direction, that it can move in a coplanar direction.

Construction elements carrying reinforcement struts can also be placed between the sides of the shell, in combination with the insulation therein fastened to the inner surface. In this case an additional fixation of the insulation element on the shell becomes possible, if at least one reinforcement strut possesses two advantageously parallel running, slotted recesses placed in at least one outer side of the U-shaped strut to form a fixation strip for the securement of insulation against the inner side. This fixation strip, in the premounted condition, runs generally coplanar with the unbent part of the outer leg. The basis of this construction is for the fixation of insulation elements which lie on a principal surface of the inner side of the shell. Thus, there is one side of the insulation element lying on the outer leg of the reinforcement strut extending out of the outer surface and impinging into the side of the of the insulation element.

For a form-fit connection of the reinforcement strut onto the shell, it is possible that at least one end surface of a reinforcement strut can possess a clamping zone, the separating distance to the overlapping side of the of the connecting leg, measured in a direction perpendicular to the run of the cross-connector, is approximately equal to the width of the stabilization area of the shell in this same direction. In this way, clamping is provided for the stabilization area in the mounted condition, which is between the clamping area of the reinforcement strut and the fastening area of the overlapping side of the shell of the cross-connector. The clamped fastening of the reinforcing strut can be made easier during its mounting, if at least one clamping area of the reinforcement strut is assigned a guide strip, along which the stabilization area of the shell, during the mounting, of the reinforcement strut onto the inner surface of the shell, can be guided before it finds an embedment between the cross-connector and the clamping area.

The reinforcement struts can be placed between the run of the sides of the shell, which extend themselves transversely to the side structure. In this case, an end located side of the reinforcement strut would be introduced into a side element of the shell in such a manner, that a cross-connector of the reinforcing strut is made to lie upon a corresponding fastening area of the side structure. In this case, the reinforcing strut would be, so to speak, pivoted about an axis which runs parallel to the side structure in a direction toward the inner surface of the shell. In this arrangement, the mounting can be improved, if the guidance path is directed to a location along that of the stabilization area of the shell, when the reinforcement strut is mounted on the inner surface and possesses an upward sloping path extending itself from a side area of the outer leg, between that side of the of the outer leg, which is remote from the cross-connector and the side area adjacent to the clamping area in a direction of the said ramp area. Along this ramping area, it is possible that the reinforcement strut of the shell, during the said pivoting movement of the reinforcement strut, glides smoothly along, until that side of the reinforcement strut, which is remote from the fastening area of the shell, impacts against that side, i.e., the corresponding bending line of the reinforcement strut and comes to rest in the clamping area in an engagement latching. Simultaneously, the fastening surface of the reinforcement strut comes to lie upon the inner surface of the shell.

Within the framework of the invention, consideration can also be given to the fact that the reinforcement struts are designated here as “end capping” and are fastened perpendicularly to the side structural elements, running in a vertical direction. Accordingly, the installation of an outer fastening area of the said end capping becomes a required item on outer surface of the shell, while a laying of an end capping becomes required on the inner surface of the shell. Consequently, then the inner fastening area is installed with sufficient clearance from the inner surface of the shell. Only when this is finished, is it possible for the outer leg, which possesses a fastening area of the reinforcing strut to be brought into the end surface side of the shell. This is done in order that a pivoting axis, parallel to the corresponding side of the shell is the center of swings in a direction toward the inner surface. In this case, sufficient grounds have been found, to establish that if the guidance area possesses first, an element of a latch bent outward from an outer leg of the reinforcement strut in the direction of the outer leg, and second, an element of a back bowed latch. The apex of the first element engages, or enters, the complementary recess of the second element, whereby the holding latch is placed in the stabilization area of the shell.

As discussed above, in the case of an invented structural element, advantageously, at least one end cap possesses an outer fastening area on its outer surface and separated therefrom, an inner fastening area. This inner fastening area lies along the length of the side structure and is placed on the inner surface of the shell.

In the case of conventional structural elements for the assembly of sectional door panels, any source of unwanted noise arising in the area of the end cap is prevented. This is accomplished in that the shell, including the thereto attached insulation, which forms the outer surface, is pressed against an outer fastening area of the said end cap. Such a work step involves additional material and labor costs. Conversely, in the case of the invented structural element, it has been shown as a favorable step, if the outer leg which has an external fastening area possesses a turned-down latch tab, which is advantageously shaped by and bounded by a “V” or a “U” cutout. Upon pressure being exerted on the outer surface, hence on the outer fastening area, the said latch tab holdingly penetrates into the interior of the end cap. In this way, it becomes possible that assembly precision, and variations in the thickness of construction material are compensated for. This is true even when the connection line, which determines the bending line of the downward pressed latch tab, is placed as an acute angle between the ends of the, for example, U-shaped slot with a surface which is perpendicular to the outer fastening areas, that is, the outer surfaces. Detailing this, an outer leg of the U-shaped slot, which is proximal to the outer fastening area, will run somewhat parallel to the outer fastening area.

As has already be explained in relation to the structuring in accord with the technology, experience has shown that it is advantageous, if a structural element possesses an insulation filling or pack, affixed to the inside of the shell and preferably in at least one element of the side structure. This insulation can advantageously be Styropor and/or a PU-foam. Especially, where this is concerned and where the shell has a stabilization area, as described above, associated with this fastening area, and based on good mounting practices, the insulation arrangement can be divided into two insulation packs running parallel to the joined surfaces of the side structure. In this case, at least one insulation element grips a stabilization area from below and at least partially enters into the side area of a side structural area. In order to avoid damage to the installation of insulation, it has shown itself as favorable, if one of the boundary surfaces of the self foaming insulation, which boundary surface is remote from the inner surface of the shell, is provided with a means to cover or confine the said insulation.

Again, in the case of conventional, double shelled structural elements, which have previously been explained, the above said covering, or confinement means, is to be so attached to the fastening area of the shell, that the fastening area will be overlapped. In the invented construction element, an opposite concept is employed, namely wherein the covering possesses or overdecks an area running somewhat parallel to the inner surface of the outer shell. Further, covering is to have at least one side area, which runs parallel to, and is superimposed on the stabilization area of the shell. The advantage of this is that an overlapping piece to cover the positioning aid between the covering and the fastening area can be avoided. Converse to this, simultaneously by means of coaction between the stabilization area and the thereon placed side area of the covering, an exact position determination of the covering can be determined. This is true, even if the separating distance between the side areas of the covering, measured perpendicularly to the extending direction, is approximately equal to the separating distance between the stabilization areas of the shell, measured in the same direction.

However, by means of avoiding additional reinforcement struts, it becomes possible, that an increase in metal thickness, which is attained by back-folding of side areas or of the covering, can be eliminated. Consequently, an invented structural element possesses, advantageously, only one reinforcement strut, placed on the limiting surface of the fastening area (which limiting surface is proximal to the inner surface of the shell) end, which is fortunately accomplished with a positioning aid in a location predetermined to be relative to the fastening area.

When the above described situation is activated, the reinforcing arrangement can possess a plurality of reinforcement elements. These are to be placed successively, with a predetermined clearance between them. In this way, the reinforcement element can be adapted to the number of hinges, which also serve for the connection of successive structural elements. This number can run to two, three or more reinforcement struts, extending in the longitudinal direction of the side structure, again with a predetermined clearance between them. Each of these can be incorporated into a group of structural elements. In these groups, one reinforcement strut can possess two, three or more bored holes for the reception of screws to affix the hinge flanges. Further, regarding the hinge flanges, two, three or more screw openings at least partially contribute to the fastening of the at least one structural element of the positioning aid.

To attain an improvement in regard to the exactness of the placement between the shell and the covering, it has proven advantageous if the reinforcing arrangement, that is to say, at least one reinforcing element, includes a groove, which encompasses the outer shell and a side area of the covering device. With this situation in place, the sides of the groove will run parallel to the stabilization area, i.e., parallel to the side area of the covering. The depth of the groove is to correspond, at least approximately, with the width of the stabilization area and/or with the width of the side of the covering device. The said widths are not limited to the stated values, but may even be larger.

In the case of construction elements, the ratio of the length of the shell in the direction of the wall element to the height of the shell in the direction of the door panel, that is, measured perpendicularly to the side elements, runs advantageously 15 or less, preferably 10 or less. This ratio or relationship assures sufficient overall stability.

As may be inferred from the foregoing explanations, an invented shell recommends itself for the assembly of an invented structural element. This recommendation is based on the grounds of having a fastening area for the affixing of hinge flanges, which fastening area possesses at least one structural element extending itself advantageously in a direction perpendicular to the outer surface. This structural element is especially a somewhat circularly curved and is bent away from the outer surface. The shell assembly also has a positioning aid section for screws or rivets to hold down the hinge flanges. Other advantages would be reinforcing struts which are aligned somewhat perpendicularly to the side structure and having an end section implanted in a side element and/or a side element which overlaps a reinforcing strut.

A reinforcement strut in accord with the invention intended for the assembly of an invented structural element, characterizes itself by a complementary engagement device in the positioning aid.

An invented sectional door panel made from the invented construction elements comprises a plurality of construction elements, which are successively arranged in the movement direction of the door panel, whereby a sectional door panel, which possesses such a construction element also possesses a guide rail arrangement with two guide rails, of which each has a first, vertically aligned, straight line section for the picking up of the sectional door panel in the closed position, and a second straight line, overhead, horizontally running section for the sectional door panel in its open situation and finally a third section, which binds the first and second sections together by a curve shaped extension.

In the following the invention is described in greater detail with the aid of the drawing, upon which all details not otherwise fully described are explained with the aid of drawings.

There is shown in:

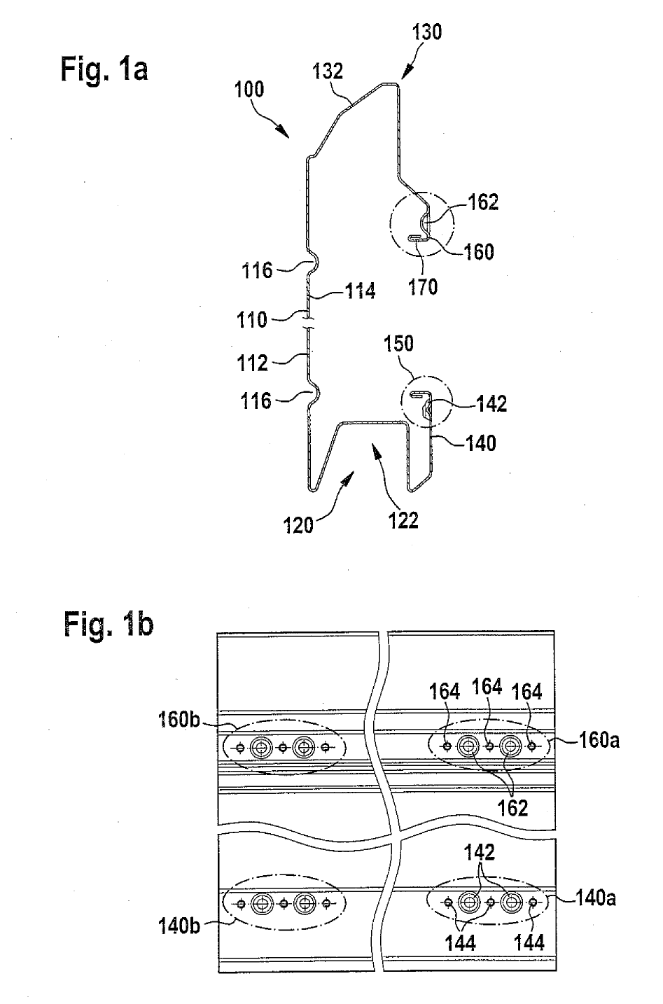

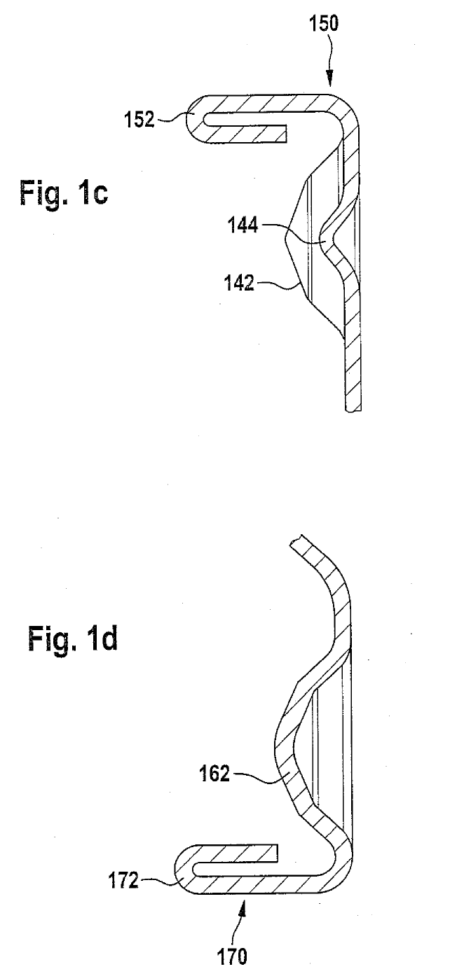

FIG. 1a a cross section of an invented shell for an invented construction element,

FIG. 1b a view of the interior surface of the shell presented in FIG. 1,

FIG. 1c the detail in FIG. 1a marked as “A”,

FIG. 1d the detail in FIG. 1a marked as “W”,

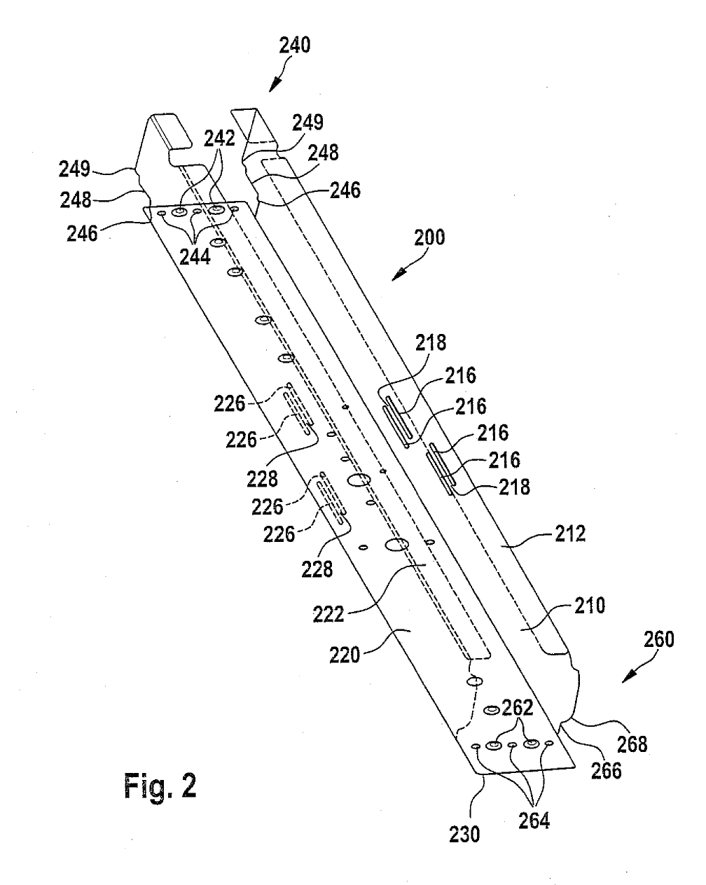

FIG. 2 a perspective presentation of an invented reinforcement strut, for the assembly of an invented construction element in accord with a first embodiment of the invention,

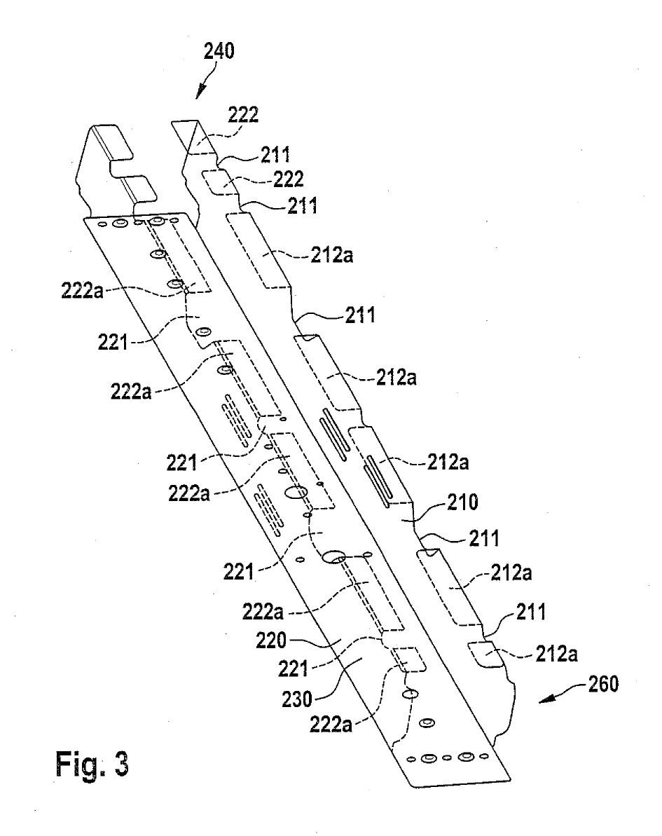

FIG. 3 an invented reinforcement strut for the assembly of an invented Structural element in accord with a second embodiment of the invention,

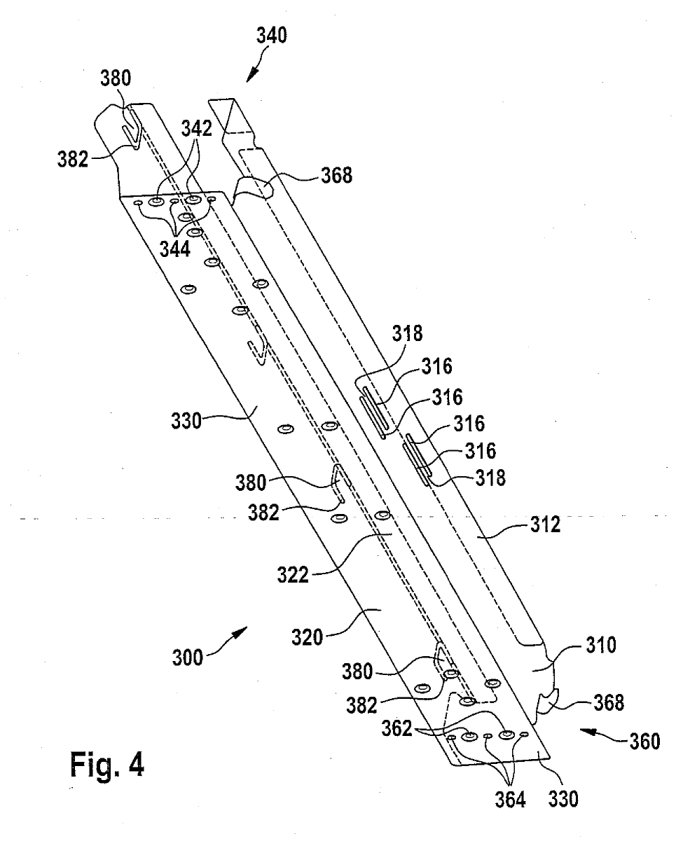

FIG. 4 a perspective presentation of an invented end cap in accord with a first embodiment of the invention,

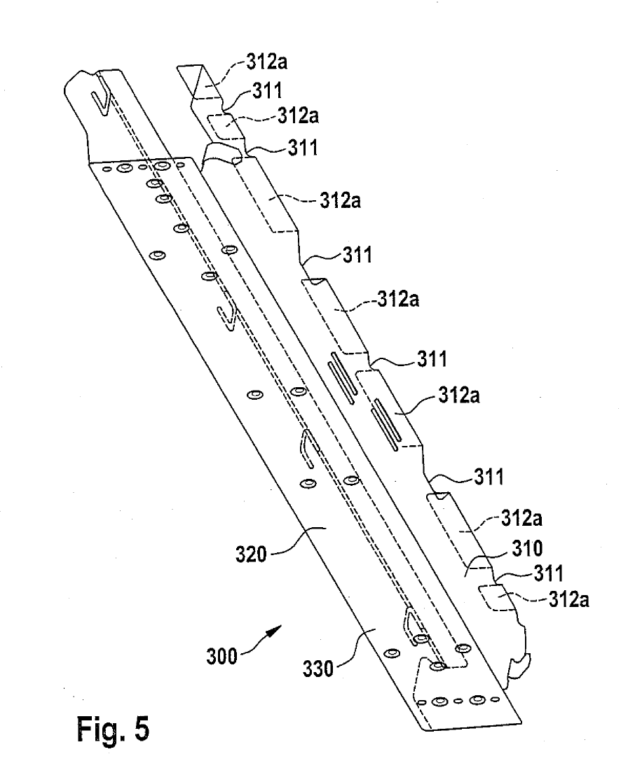

FIG. 5 a perspective presentation of an invention end cap in accord with a second embodiment of the invention.

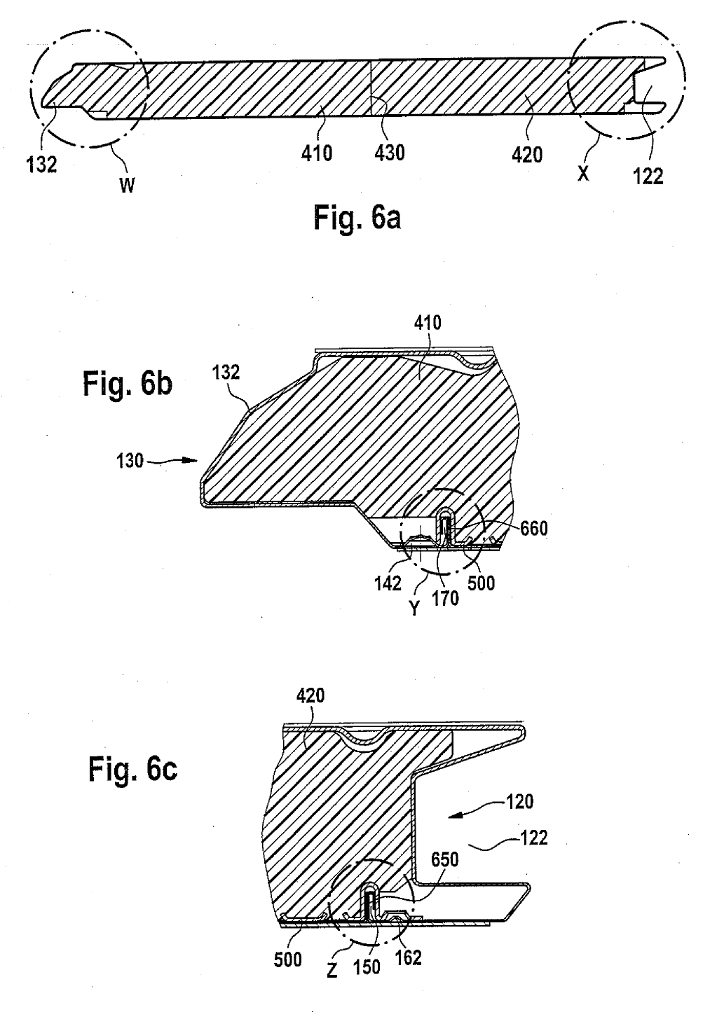

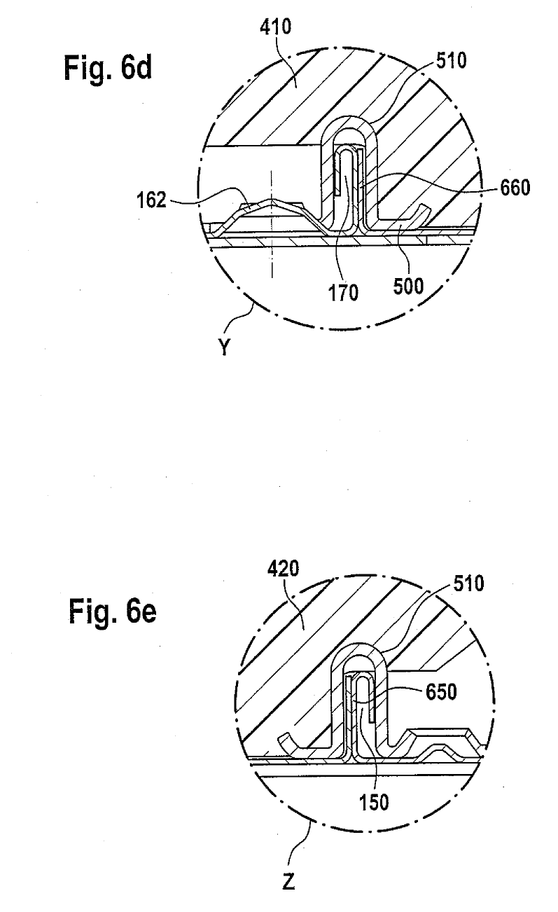

FIG. 6a a sectional presentation of an invented construction element in a sandwich type assembly,

FIG. 6b a detail in FIG. 6a designated with W,

FIG. 6c a detail in FIG. 6a designated with A,

FIG. 6d a detail in FIG. 6b designated with Y,

FIG. 6e a detail in FIG. 6c designated with Z,

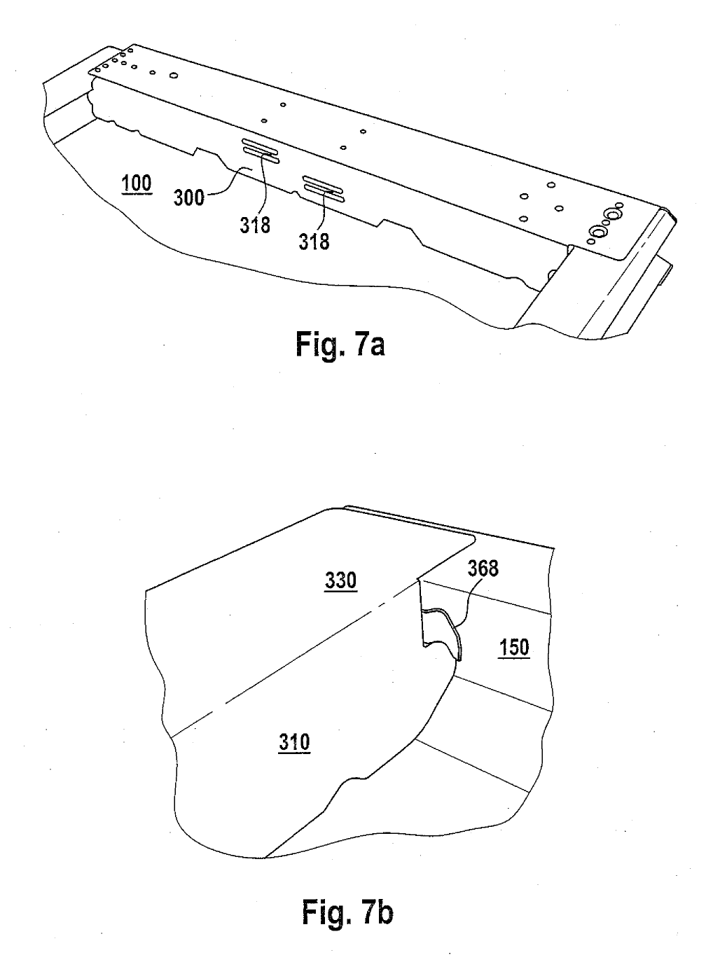

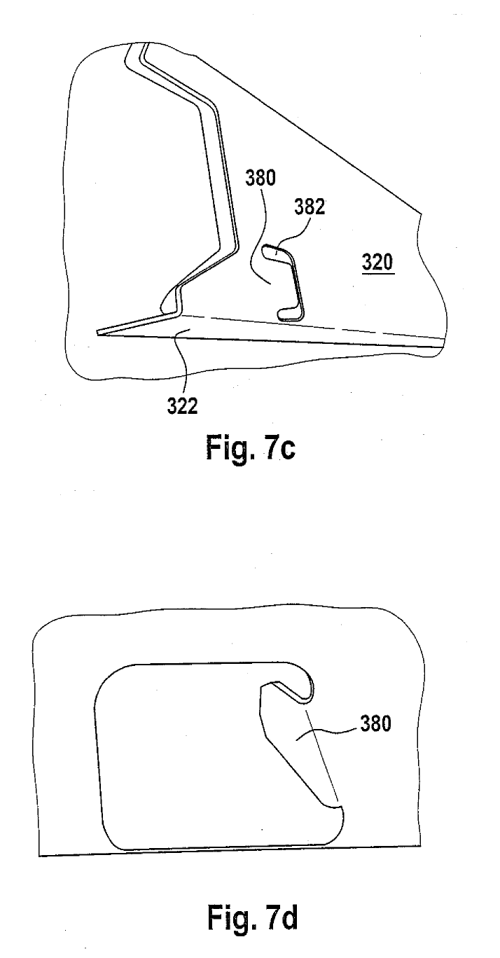

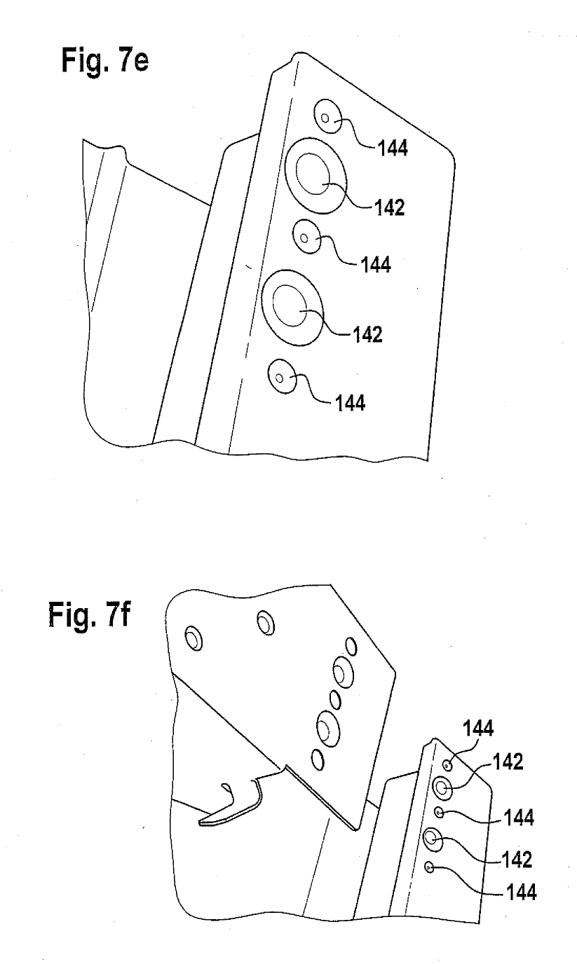

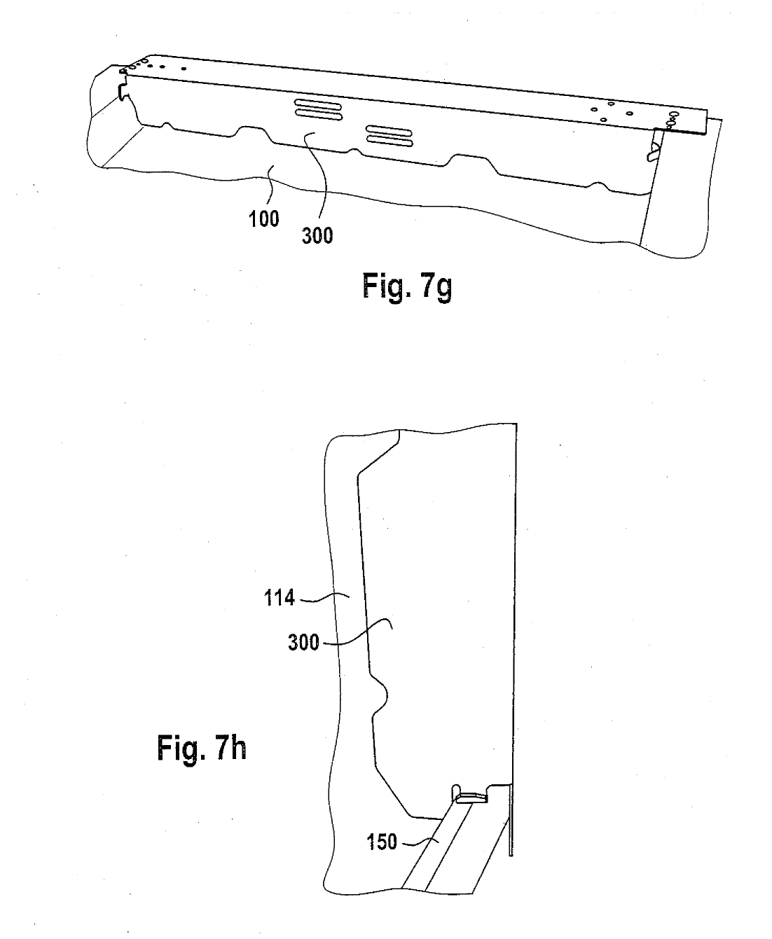

FIG. 7a an invented shell with a superimposed invented end cap,

FIG. 7b a detailed presentation of the invented end cap of FIG. 7a,

FIG. 7c a detailed presentation of the press-latch for the invented end cap of FIG. 7a, prior to its being bent,

FIG. 7d a detailed presentation of the press-latch for the invented end cap of FIG. 7a, after its being bent,

FIG. 7e a structural element group in the end cap assigned to the fastening area of the shell,

FIG. 7f the end cap in accord with FIG. 7a prior to the mounting thereof,

FIG. 7g and FIG. 7h the end cap of FIG. 7a during its mounting,

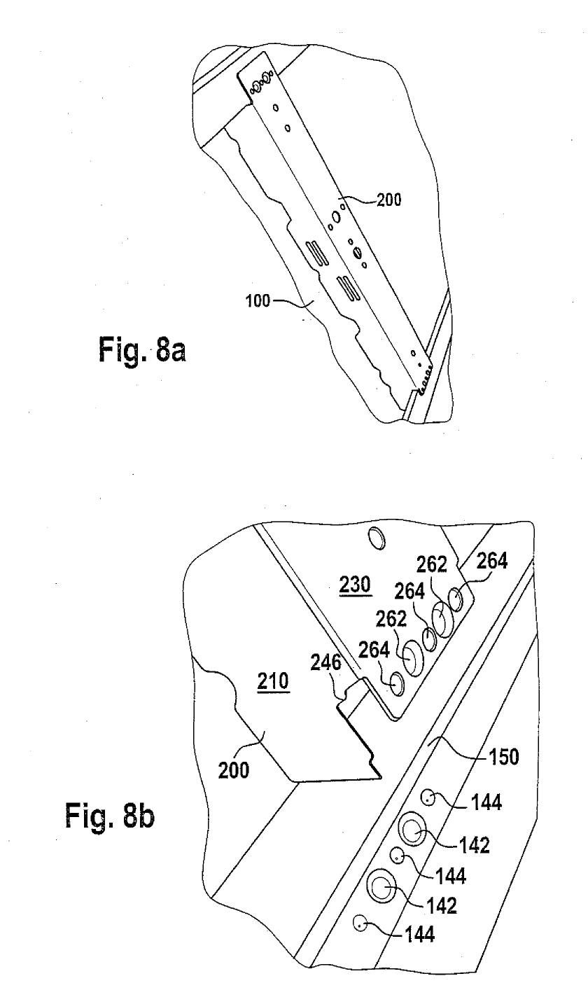

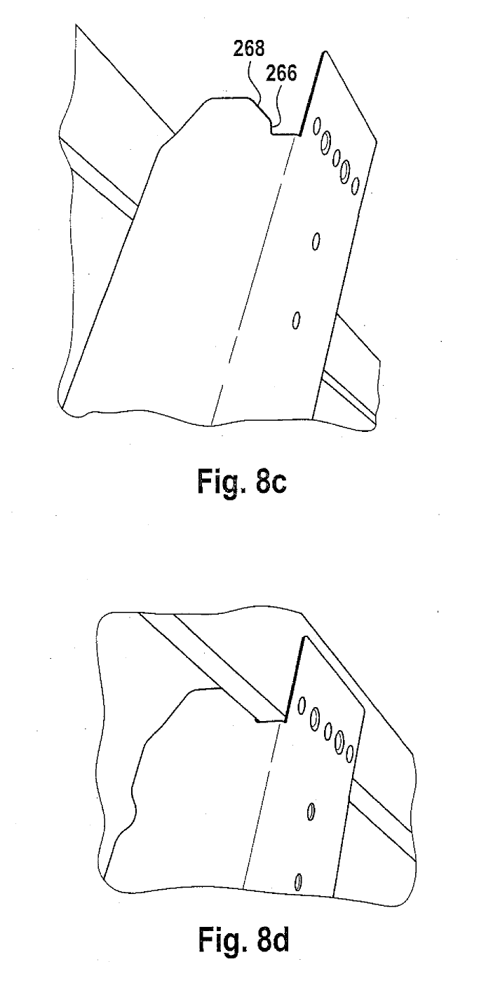

FIG. 8a a perspective presentation of an invented reinforcement strut following it mounting on an invented shell,

FIG. 8b a detail presentation of a first end located side of the reinforcement strut prior to its being mounted,

FIG. 8c a detail presentation of a second end located side of the reinforcement strut prior to its being mounted,

FIG. 8d a detail presentation of the second end during its mounting,

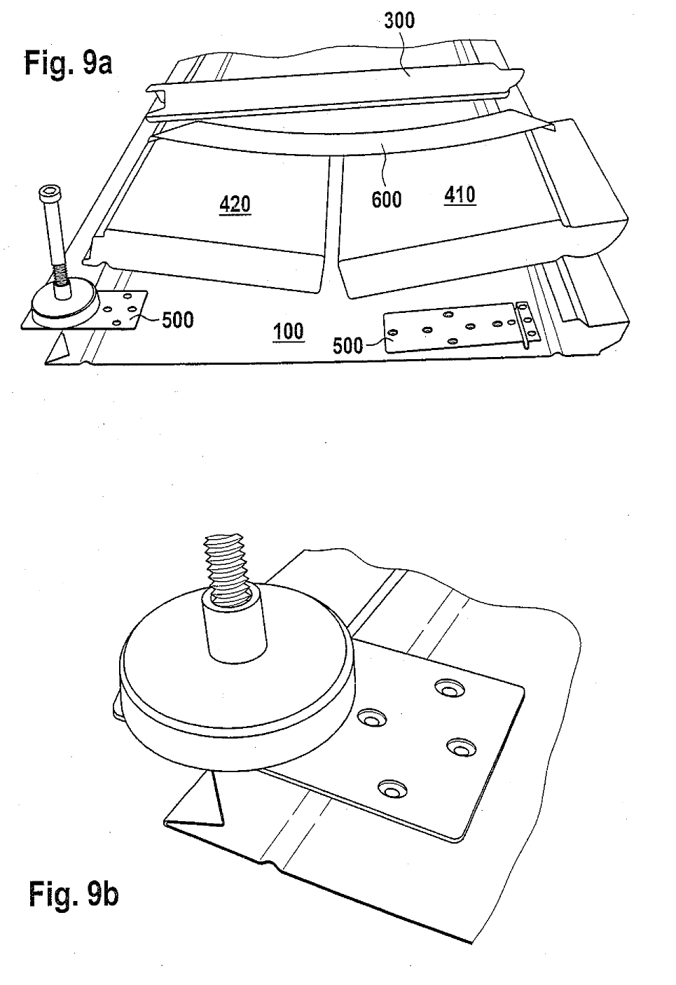

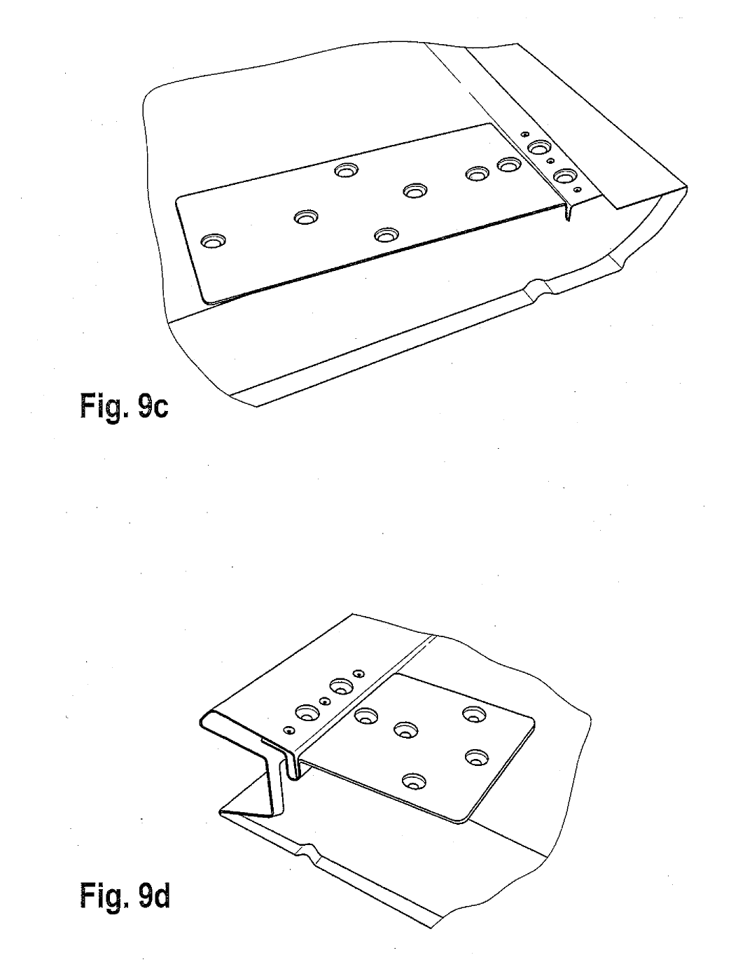

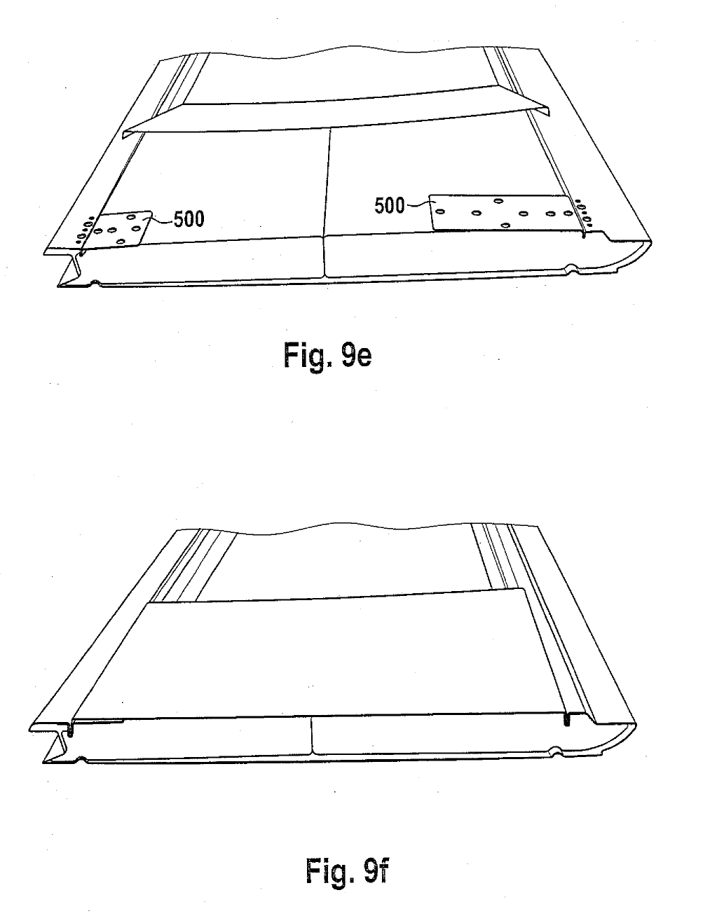

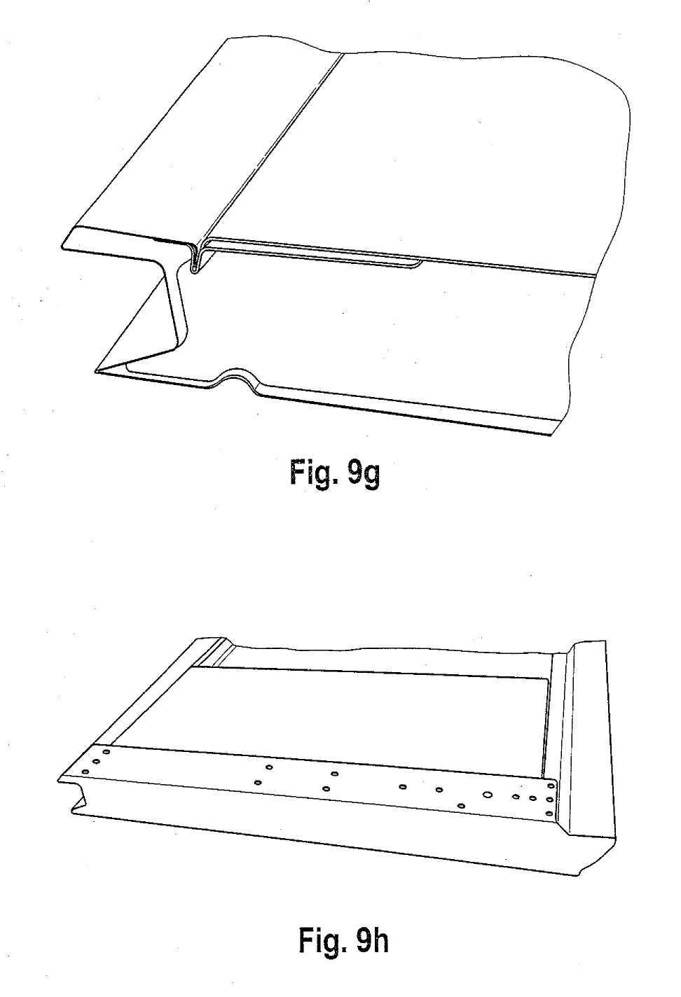

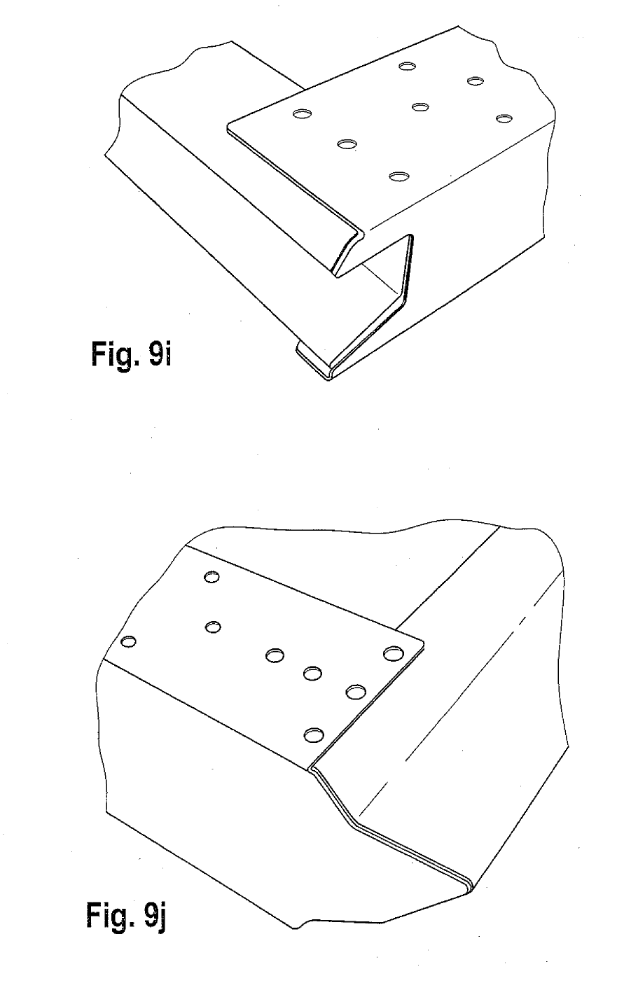

FIG. 9a individual parts of an invented construction element shown in sandwich assembly style,

FIGS. 9b to 9j individual steps of the mounting of an invented construction element in sandwich assembly style.

A shell 100 presented in FIG. 1, consists of a cold rolled steel sheet and possesses a bottom 110 having a planar, outer boundary forming the door panel. Shell 100 has also an inner surface 114 lying opposed to the outer surface 112. Seen also in FIG. 1 are the partially back-rolled side structures 120 and 130, which run longitudinally along the shell 100. In the side structure 120 an open recess 122 is incised, running along the length of the shell 100. Fastening area 140 and stabilization area 150 connect to this recessed side element 120. The side structure 130 is shaped into a projecting extension 132 which complementarily fits the recess 122. This extension 132 runs in a longitudinal direction along length of the shell 100. To this extension 132 are attached fastening area 160 and stabilization area 170. Considering the shape and function of the (three dimensional) recess 122 together with its complementary projection 132, notice is officially taken of corresponding explanations in EP-B-370 376 and EP-B-370 324.

The fastening areas 140 and 160 extend themselves, maintaining the same clearance between them, parallel to the inner, shell bottom surface 114. Likewise, stabilization areas 150 and 170 align themselves transverse thereto, starting from fastening areas 140, 160 and proceeding across the shell bottom 110. FIGS. 1c, 1d show clearly that stabilization areas 150, 170 are fold back on themselves and run along a bending line 152, 172 which runs parallel to the length of the shell 100.

Fastening areas 140, 160, are provided with linearly set positioning aids 142, 144, 162, 164, which proceed along the said fastening areas, running parallel to the inner surface 114 of the shell 100. FIG. 1b demonstrates further, that the positioning aids 142, 144, 162, 164 consist of groups of structural elements, wherein groups 140a, 140b and groups 160a and 160b are, in succession, longitudinally aligned along the side structures 120, 130.

With this arrangement, each group of structural elements 140a, 140b, 160a, 160b includes first, two structural elements 162, this having a substantial structural diameter and second, three structural elements 164 of smaller diameter. The structural elements 142, 162 are, in the view given by FIG. 1b, circular in shape and possess in a cross-sectional plane therethrough, a polygonal outline. Of this, the polygonal cross-diameter measures ca. 2 to 4 mm, preferably 3 mm. The structural elements 144, 164 are, as seen in FIG. 1b, likewise essentially circular in plan view. These, however, possess a smaller diameter than do the said structural elements 142, 162. The diameters of 144, 164 run some 1 to 2 mm, preferably 1.25 mm. The structural elements 142, 162 of each group maintain the same separating distance from one another. In this way, the structural elements 142, 162 enable the positioning of equally fabricated, successively aligned, reinforcement struts and/or hinge flanges to be randomly installed at different locations.

The structural elements of the structural element group, namely, 140a, 140b, 160a, 160b are longitudinally positioned in a stretch no longer than 50 mm, preferably no longer than 40 mm. The structural elements of different groups have a clearance from one another of 100 mm or more. As seen in FIG. 1a, the shell bottom 110 possesses a multitude of longitudinal metal impressions 116 running parallel to the side structures of the shell 100.

The reinforcement strut 200 illustrated in FIG. 2 essentially has a U-type construction. Two outer legs 210, 220 are evident and are joined by a cross-connector 230. The outer legs 210, 220 extend along their respective side of the transition piece 230 and rise above, drawing-wise, the cross-connector 230 and run parallel thereto. The outer legs 210, 220, remote from the transition piece 230, are bent inward to form narrow fastening flanges 212, 222. Incised into the sides of the outer legs 210, 220 are shown slotted recesses 216, 226 aligned in parallel. Between these slots are to be found inward bulged projections in the legs 210, 220, which bulges serve for the affixing of insulation material onto the inside of the legs 210, 220. A first axial end area 240 of the illustrated reinforcement strut 200 can be so inserted into the side structure 130 of FIG. 1a showing the shell 100, that the corresponding end of the cross-connector 230 is caused to lie upon that bordering surface of the fastening area 160, which bordering surface is remote from the inner surface 114 of the shell bottom 110. The result of this arrangement is, that in the axial end area of the cross-connector 230, a complementary adjunct to the to the engagement structure of the positional aid is made, which is comprised of two inward metal impressions 242 and three recesses 244. Accordingly, the impressions 242 and 244, when in a mounted situation, coincide with the structural elements 162, 164. In addition, in this end area 240 of the reinforcement strut 200 a clamping area 246, which stands separated from the cross-connector 230 in the side of the outer legs 210 and 220. Accordingly, the separating distance between the clamping areas 246 and the end of the cross-connector 230 corresponds to the width of the stabilization area 150, when seen in a perpendicular direction to the shell bottom 110

As a result, the stabilization area 150 can be clamped in place when mounted between the clamping area 246 and the cross-connector 230. Accordingly, the mounting is thereby simplified, in that the clamping area 246 extends itself into clamping areas 248 and 249, thus increasing its distance from the cross-connector 230.

The end 260, which lies longitudinally opposite to the end 240 of the reinforcement strut 200, is insertable into the open recess 122 of the end structure 120 of the shell 100. The result of this is that the bordering surface of an end of the cross-connector 230 to which it is proximal. The result of this is that, an inner boundary surface of an end of the cross-connector 230, the said boundary surface being proximal to the fastening leg, is caused to lie on a bordering surface of the fastening area 140, this bordering surface being remote from the shell bottom 110. It thereupon follows that in the end area of the cross-connector 230, an engagement device has been installed, which is comprised of penetrative impressions 262 and recesses 264, which, when mounting is complete, complementarily, holdingly coincide with the respective impressions 142, 144 of the fastening area 140. The end 260 has been designated to have a clearance away from the clamping area 266 of the cross-connector 230. This allows the stabilization area 150 of the shell 100, when in the mounted condition, to be clamped between the clamping area 266 and the end of the cross-connector 230.

Accordingly, the mounting has again been simplified, this time due to the ramped area 268, which extends above (drawing-wise) the clamping area 266. The ramped area 268 is a part of the end assembly 260 of the reinforcement strut 200. Consequently, at this point, the bending line 152 of the stabilization area 150, in the mounted condition, slides along the ramp area 268 after the reinforcement strut 200 has already been inserted in the side structure, in order that a pivoting can be made about a pivotal axis which is parallel to the longitude of the side structure 130, wherein the said pivoting would be in the direction toward the shell bottom 110. This swing continues until the stabilization area 150 becomes frictionally engaged between the clamping area 266 and the cross-connector 230.

It is obvious, that the reinforcement strut 200, which lies beside the engagement latching, that is, beside the said impressions or perforations, 262, 264, 242, 244, has even more perforations. By means of these additional perforations screw hole locations for the securement of hinge flanges of various shapes can be factory made.

Examining FIG. 3, which shows another embodiment of the invention, namely of a somewhat changed reinforcing strut. This reinforcing strut essentially differentiates itself from the embodiment shown in FIG. 2, in that the outer legs 210, 220, on their sides, which sides are remote from the cross-connector 230, possess impressions 211, 221, designed to fit, for example, a raised, i.e., upward bowed, surface structure, which is created by a longitudinal, rounded crease 116 in the inner surface 114 of the shell 100. By means of the impressions 211, 221, the fastening areas 212, 222, that is, the corresponding fastening leg, become subdivided into a multiplicity of fastening increments. In the case of both of the embodiments of the invented reinforcement strut 200 shown respectively in FIGS. 2 and 3, the fastening areas 212, 222; 212a, 222a, which are remote from the cross connector 230, are attached to the inner surface 114 of the shell 100 by adherent means. In this way, it becomes possible for a layer of adhesive material, having a depth of some 0.5 mm to be applied. The advantage lies in the fact that this can act to enhance the acoustic barrier.

In FIG. 4 is shown a reinforcing strut, which is designed to serve as an end cap 300. In like manner to the above construction of reinforcing struts, this end cap 300 is made in an essentially U-shape, with two outer legs 310, 320 and a cross-connector 330 therebetween. On the sides of the outer legs 310, 320, which extend away from the cross-connector 330, are formed inward bent, fastening legs with fastening areas 312, 322. These fastening areas are placed in opposition to one another, relative to an axis running transversely in a higher plane across the longitudinal extent of the cross-connector 330. The fastening areas are separated from one another at a distance determined by the thickness of the wall material of the shell 100. Accordingly, the fastening area 322 lies on the outer surface of the shell 100 while the fastening area 312 is to be found on the inner surface of the shell 100. If, under these circumstances, the end cap 300 slidingly fitted onto the shell 100 in such a manner, that it overrides the side of the shell 100 with the fastening area 322, the outer leg 320 and the cross-connector 330. With this arrangement, a circumstance can arise, wherein an end area 340 of the end cap 300 enters into the projection 132 of the shell 100 while an end 360 of the end cap 300 is placed within the structure 130 of the shell 100, whereby, an alignment occurs through recesses 364, or by impressions 362 which are penetrated by recesses, or otherwise with the structures 162, 164; 142, 144. This function allows a desirable positioning of the end cap 300 to be assured and positional aids for the screws to be put in place. The said screws are to penetrate through the recesses 362, 364, 342 and possibly 344 for the securement of hinge flanges.

Placed between slotted recesses 316, the outer leg 310 has a continuously running fixation area 318. This fixation area 318 serves to secure, one the outer leg 310, insulation in either a loose or a packaged form. The outer leg 320 is furnished with clips 380, which are bordered by U-shaped slots 380. These clips 380 have the purpose of being turned along a bending line 152, 172 toward the inner space of the end cap 300. The course of the said bending line 152, 172 is defined by slots shaped recesses 382, 172. Accordingly, the said bending line 152, 172 runs at an acute angle to a vertical surface on the fastening area 322, or to the cross-connector 330. The result of this is, that in the mounted condition, by means of bending the clip 380, the side of the shell 100, which contacts the fastening area 322 will be pressed against the fastening area 322.

In the neighborhood of the end sides 340, 360, the outer leg 310 is furnished with guiding means in the form of back-turned tabs 368. The sides of these tabs 368, which extend outward from the cross-connector 330, have a clearance away from the boundary surface of the cross-connector 330. The extent of this clearance is equivalent to the height of the stabilization area 150, 170 of the shell 100. The said boundary surface is proximal to the fastening area 312, 322 of the cross-connector 330. The result of this arrangement is that in the mounted situation, the stabilization areas 150, 170 become clamped between the clips 380 and the ends of the cross-connector 330.

When mounting is complete, the side of the shell 100 is placed, in such a manner between the fastening area 322 and the cross-connector 330, that the fastening area 312, which extends itself from the cross-connector 330 is accordingly located above the inner surface 114 of the shell 100. This positioning allows that an adhesive layer placed on one of the boundary surfaces of the fastening area 312 cannot migrate onto the inner surface 114. As soon as a side of the shell 100 seats itself on the outer leg 320, then the end cap 300 pivots around an axis, which runs parallel to the longitudinal axis of the said cap, whereby the end cap 300 is rotated onto the inner surface 114 of the shell 100. The result of this is that, the bordering surface of the fastening area 312 comes to bear on the inner surface 114, where by a material contact closure occurs. Simultaneously, one of the sides of the clip 368, which is proximal to the side of the cross-connector 330 makes a holding engagement at the bending line 152, 172. The result of this is that stabilization area 150, 172 becomes clamped between clip 368 and the end cap 300. Upon the sliding on of the end cap 300 onto the side of the shell 100, the bending line 152, 172 serves the said clip as a guiding means, which slides along the stabilization areas 150, 170. Even the cross-connector 330 of the end cap 300 possesses a multiplicity of additional perforations, in order that the installation of hinge flanges with different patters of screw holes can be carried out easily.

As may be further inferred from FIG. 4 for the making of a complete construction element, two mirror-image end caps 300 are necessary, insofar as the side structure of the shell 100 is to show variation in appearance and/or a complementary suitability of the shapes of the end caps 300 to the contour of the shell sides is desired. In case such a suitability is not specifically desired, and both outer legs 310, 320 of the end cap 300 is fabricated with both attachment areas 318, 328 as well as clips 380, it is possible that identical structural elements can be made for both sides of the shell 100.

The embodiment of the invention presented in FIG. 5 essentially differs from that of FIG. 4, in that the side of the outer leg 310, which is remote from the cross-connector 330, for the purpose of matching a structure of the inner surface 114, i.e., the shell bottom 110 of the shell 100, possesses a plurality of indents 311, by means of which, the fastening area 312 can be subdivided into a multiplicity of segments 312a. These segments 312a are intended to be placed on the inner surface 114 of the shell bottom 110.

FIG. 6a shows, in a schematic sectional drawing, another embodiment of the invention. This version illustrates two insulation elements 410, 420, in a sandwich type presentation which is to be inserted into the shell 100 of the construction element. As is particularly clear in FIGS. 6c, 6d, the sides of the insulation elements 410, 420, which run parallel to the side structures 120, 130 of the shell 100, engage themselves in those said side structures. Simultaneously the said element sides engage the stabilization area 150, 170 from below.

The structural components shown in FIGS. 6a to 6e additionally contribute to the shell 100, besides the end cap 300 and the insulation elements 410, 420, also reinforcement struts, which, in the area of the extending sides of the insulation elements 410, 420, which run parallel to the wall structures 120, 130 and which are between the insulation elements 410, 420 on the one side, and the shell 100, i.e., the side structure 120, 130 of the shell 100, on the other. These are clearly depicted on the FIGS. 6b to 6e. Further, the structural element still possesses a covering device intended to protect the bordering surface of the insulation material elements 410, 420, wherein the said bordering surface which extends away from the inner surface 114 of the shell 100. The covering equipment comprises a covering area, the sides of which are parallel to the covering area which area runs parallel to inner surface 114. Further, in this respect, the equipment includes two sides 650, 660 which run parallel to the stabilization areas 150 and 170.

As can easily be seen in FIGS. 6d and 6e, the sides 650 and 660, as well as the stabilization areas 150, 170 are enclosed in the groove 510 of the reinforcement strut 500. This is so done in order to enable an affixing of the covering apparatus on the shell 100. Additionally, it is to be observed, that in the FIGS. 6d, 6e, the reinforcing elements 500 are provided with recesses, which engage themselves in the structural elements 142, 144, 162, 164 of the shell 100. Also, the reinforcing elements 500 possess additional perforations, in order that the installation of hinge flanges can be made possible.

FIG. 7a shows a perspective presentation of an end cap 300 mounted on a shell 100. Slots 318 are also visible.

In FIG. 7b is to be seen, the manner in which self-back-turned clips 368 engage the stabilization area 150 from below, so that the said stabilization area 150 is clamped between first: one of the bordering areas of the cross-connector 330, which bordering area is proximal to the fastening area 140 and second: an end structure of the cross-connector 330. In FIG. 7c, the clamping clips 380, which are proximal to the U-shaped slot 382 can be seen. These are employed for the pressing of the shell 100 against the outer fastening area 322 in the end cap 300, as is seen in FIG. 7d, where the clip 380 has been pressed inward. In 7d the bending line 152, 172 closes an acute angle with a perpendicular surface on the outer fastening surface 322.

FIG. 7e brings about, in detail, a structural element group. This consists of two structural elements 142 of large diameter and deeper depth as well as of three structural elements 144 of lesser diameter and of a lesser structural depth.

FIG. 7f makes known, that the separating distance of individual recesses, namely 364 for example, which has penetrative recesses 362 on the end side of the cross-connector 330 of the end cap 300, wherein the spacing of the said recesses coincides with the spacing between the structural elements 142, 144 of the structural group on the fastening area 140 of the shell 100.

FIGS. 7g and 7h show the mounting of the end cap 300 onto the shell 100. In this operation, the end cap 300 is so tilted, when pushed onto the shell 100, that the inside fastening area 322 is guided, with a separating distance, over the inner surface 114 of the shell 100, whereby the end cap 300, with the aid of the clips 368, is guided along the stabilization area 150. As soon as the side of the shell 100 comes to rest in the outer leg 320 of the end cap 300, then the end cap 300 swings about a vertical axis, which is parallel to its longitudinal axis. This enables the fastening area 322 to come into contact with the inner surface 114 of the shell 100

FIG. 8 teaches that on the end side of the cross-connector 230, which is part of the reinforcement strut 200, the individual recesses 264 and the individual perforations 262, in regard to their shape and positioning, coincide with the shape and positioning of the respective individual structural elements 162, 164 on the fastening area 140 of the shell 100. In this positional arrangement, a side of the outer leg 210 of the reinforcement strut 200 is made in such a subdivided manner, that concerning an clamping zone 266, the distance of separation from the cross-connector 230 represents almost equally the height of the stabilization area 150. This said separation extends itself by a step calling for a greater distance. In turn, this now increased separation again adds another distance to itself. Thus the sliding insertion of the reinforcing strut 200 below the stabilization area has been made easier.

In the neighborhood of the side 260, the reinforcement struts 200, according to FIG. 8d, in like manner, dead recesses 262 and penetrating recesses 264 are provided. The shape and positioning of the said recesses 262, 264 coincides with the shape and positioning of a structural group in the fastening area 160 of the shell 100. On this side, the clamping area 266 rises in a ramp 268, whereby, by means of the side of the stabilization area 150 of the shell, which side was created by bending line 152, during the mounting operation, the reinforcement strut 200 can slidingly move along the said ramp 268. This movement continues until the reinforcement strut 200 finds itself frictionally engaged between the clamping area 266 and the side of the cross-connector 230. This is the situation a pictures in FIG. 8d.

Now turning to FIG. 9a where, for the making of a construction element in parts which are assembled in sandwich style, there may be named a shell 100, insulation elements 410, 420, reinforcement struts 500, an end cap 300 and a covering apparatus 600. Below is described the mounting of a structural element, which is, so to speak, laminated in sandwich form:

The reinforcing strut 500 is first installed on the one of the boundary surfaces of the fastening area 140. This is facilitated by the use of magnets. The boundary surface 140 is above the inner surface 114 of the shell 100. This may be seen on the FIGS. 9a, 9b.

In a successive step, the insulation elements are inserted between the reinforcement strut 500 and the inner surface 114 of the shell 100. This brings the insulation elements into the wall structure 120, 130 also of the shell 100. Thus the insulation elements 410, 420 lie adjacent to one another along a centrally running division surface 430, which is aligned transversely to the longitudinal extent of the inner surface 114. This situation may be seen in FIGS. 9c to 9e. Upon the completion of the above, the stabilization area 150, 170 falls into the corresponding grooves 510 of the reinforced struts 500. Finally, the covering apparatus is so placed upon the bordering surfaces, which extend from the inner surface 114, that the sides 650, 660 of the covering apparatus engage themselves in the grooves 5010 of the reinforcement struts 500. The result of this is that the covering apparatus becomes form-fit on the side structure 120, 130 of the shell 100. Finally, the end cap 300, the sides of the shell 100, the insulation elements 410, 420 are all installed. When this is completed, the holes and recesses in the side areas of the end caps 300 coincide with those of the structure elements 162, 164 of a structural group on the end of the fastening areas 140, 1′60 of the shell 100. This is evident in the FIGS. 9h to 9j.

This invention is not limited by the embodiments exhibited and explained in the drawings. Consideration has been given to the employment of differently conceived positioning aids or the like. The possibility exists, that the reinforcing struts may be of different construction and/or be attached to the shell in a different manner. Also, a plurality of variations of “sandwich type” assemblies are possible.

1. A structural element for the assembly of a sectional door, wherein the said door possesses two parallel panels, which are movable along a predetermined path between a closed and an open setting of the sectional door and wherein the said structural element also possesses, for the formation of a predetermined side structure, a shell, in particular a sheet metal shell which incorporates, in part, self back-folded metal doubling, wherein the said shell also possesses an outer exposed surface and opposite thereto is to be found an inner exposed surface, which, in their combined state, and when in the closed position of the said sectional door, isolate the interior space which is to be closed off, and whereby at least one side structure of the shell possesses mutually successive, individual hinges, which are so linked together and have separating distances therebetween that they extend themselves parallel to the inner surface as well as serve for the affixing of at least one fastening area running in the direction of the travel of the movable panel, therein characterized, in that the fastening area possesses a series of item, these being, namely: a structure which extends itself at right angles to the outer surface, this structure being, for example, a somewhat circular indentation; a completed positioning aid to the screws which are located to secure hinges and/or rivets and/or reinforcement struts, which are placed on an inner surface and have an end section inserted into at least one side structure and are designed to overlap the side structure.

2. A structural element in accord with claim 1, therein characterized, in that the invented positioning aid be made of at least a group of two, three or more adjacently aligned structural elements arranged along the longitudinal length of the side structure, whereby the said structural elements would be complementary to a group, a hinge, and/or a reinforcement strut.

3. A structural element in accord with claim 2, therein characterized, in that, at least two structural elements of a group, placed in a sectional plane transverse to the longitudinal extent of the plane of the side structure, are approximately equally shaped.

4. A structural element in accord with claim 3, therein characterized, in that at least two structural elements of a group, in a sectional plane perpendicular to the longitudinal direction of the side structure, are differently fabricated, in that they possess different side thicknesses and/or diameters.

5. A structural element in accord with claim 2 therein characterized, in that the structural elements of a group are arranged in a longitudinal direction of a side structure, which has a length of 80 mm or less, especially 60 mm or less, but especially recommended at a length of 40 mm.

6. A structural element in accord with claim 2, therein characterized, in that at least one side structure possesses two, three or more adjacently neighboring groups of structural elements in the longitudinal direction of the side structure, whereby individual structural elements in adjacently arranged groups are separated from one another by clearances of 200 mm or more, especially 400 mm or more or particularly recommended, of 600 mm or more.

7. A structural element in accord with claim 2, therein characterized, in that structural elements of the same cross-sectional shape, which lie within different groups, exhibit the same longitudinal separating distance from one another.

8. A structural element in accord with the principal concept of claim 1, therein characterized, in that it extends itself along the side within a fastening area which area is transverse to the outer surface, parallel to the side structure and proceeds from the fastening area in the direction of the inner surface, as well as, advantageously being aligned relative to a bending line, which runs parallel to the longitudinal direction of the side structure and is enabled to overlap a self, back-folded, stabilization area, whereby the bending line runs separately from the inner surface of the shell with a separating distance of 15 mm or more, preferably 25 mm or more.

9. A structural element in accord with claim 1, characterized in that at least one reinforcement strut having a fabricated latching structure, which is advantageously located on that bordering surface of the fastening area, which is remote from the inner surface of the shell and/or from the bordering surface which is proximal to the said inner surface and advantageously with a complementary connection to at least one structural element of the positioning aid.

10. A structural element in accord with claim 9, therein characterized, in that the latching structure, when mounted, is engaged, at least to a partial extent, in a structural element of the fastening area opening element, whereby its latch engagement is in the form of a projection holdingly entering an opening, which opening is in a structural element and/or in a complementary opening shape of the said structural element of the fastening area, wherein it is at least partially received in an open recess of said structural element.

11. A structural element in accord with claim 9, therein characterized, in that at least one reinforcement strut possesses one connection surface located on one of the inner or outer surfaces of the shell and advantageously, adherently connected with the said inner or outer surfaces, especially by means an adhesively coated fastening surface.

12. A structural element in accord with claim 9, therein characterized, in that at least one reinforcement strut is made in a U-shape with two outer legs and one cross-connector therebetween, whereby a gripping structure is, advantageously, caused to be on the said cross-connector and is constructed to be somewhat parallel to an adjacent side area of an outside leg.

13. A structural element in accord with claim 12, therein characterized, in that on each outer leg of above said reinforcement strut a fastening area is installed, whereby the fastening surfaces thereof advantageously extend themselves into the inner space created between the outer legs of the reinforcement strut, that is to say, they are angled to enter this space.

14. A structural element in accord with claim 9, therein characterized, in that at least one reinforcing strut possesses, in its outer leg, a securement area, which is advantageously placed between two slots running parallel to each other for the secured fastening of insulation elements located between the inner sides of the shell and the outer leg.

15. A structural element in accord with claim 9, therein characterized, in that an end of a reinforcement strut possesses a clamping zone, the clearance of which away from a cross-connector, measured in a perpendicular running direction relative to the said cross-connector represents, approximately, the width of the stabilizing area, whereby the stabilization area is placed between the clamping area and the cross-connector.

16. A structural element in accord with claim 15, therein characterized, in that at least one clamping area is assigned to a guide area, along which the stabilization area runs, upon the mounting of the reinforcement strut on the inside of the shell and prior to it's being arrested between the cross-connector and the clamping area.

17. A structural element in accord with claim 16, therein characterized, in that the guiding area possesses a rising ramp leading from a side area lying between that side of the outer leg, which extends from the cross-connector and the clamping area and extending in the direction of the said clamping area.

18. A structural element in accord with claim 16, therein characterized, in that the guiding area possesses at least one reversed clip, which is bent to the outside from an outer leg and in a direction toward the outer leg.

19. A structural element in accord with claim 9, therein characterized, in that at least one reinforcement strut is made as an end cap to overlay an end of the shell.

20. A structural element in accord with claim 19, therein characterized, in that an end cap possesses an outer fastening surface lying on the outer surface and a longitudinal running inner fastening area, having a clearance from said outer fastening surface and lying on the inner surface of the shell.

21. A structural element in accord with claim 20, therein characterized, in that the outer leg, which has an outer fastening surface, possesses a press clip formed from advantageous, somewhat U-shaped slot and upon exerting pressure on the outer surface of the shell on the outer fastening area of the end cap, the said press clip is bent into the interior of the end cap.

22. A structural element in accord with claim 21, therein characterized, in that a connection line between the ends of the U-shaped slot closes an acute angle with a normal line to the surface on the outer fastening surface, that is, on the outer surface of the shell.

23. A structural element in accord with claim 1, characterized by means of an at least partially self supporting insulation packing, especially consisting of Styropor and/or foamed PU and lying on the inner surface of the shell and advantageously in at least a side structure thereof.

24. A structural element in accord with claim 23, therein characterized, in that the insulation arrangement possesses at least two insulation elements, separate from one another and deposed along a separating surface running parallel to the side structure.

25. A structural element in accord with claim 23, therein characterized, in that at least one insulation element possesses a side area, which side area connects a stabilization area and said insulation element is inserted in a side structure.

26. A structural element in accord with claim 23, characterized by means of a covering apparatus superimposed on a bordering surface of the insulation arrangement, which surface is remote from the outer shell.

27. A structural element in accord with claim 26, therein characterized, in that the covering apparatus possesses a covering area running somewhat parallel to the inner surface of the outer shell and at least one side area running somewhat parallel to the stabilization area of the shell and the thereon situation side area.

28. A structural element in accord with claim 1, characterized by means of one reinforcement strut lying against that boundary surface of the fastening area proximal to the inner surface of the shell and which said arrangement stands, relative to the reinforcement strut held by the fastening area, advantageously with the positioning aid.

29. A structural element in accord with claim 28, therein characterized, in that the reinforcement means has two, three or more reinforcement elements arranged next to one another in the longitudinal direction of the side structure, wherein, each said reinforcement element is provided with a group of structural elements.

30. A structural element in accord with claim 29, therein characterized, in that at least one reinforcement strut possesses two, three or more recesses for the acceptance of the fastening of screws to secure hinge flanges, of which, advantageously, at least one partially includes a structural element of the positioning aid.

31. A structural element in accord with claim 28, therein characterized, in that the reinforcement strut possesses a stabilization area of the shell and a side area of the groove which secures the covering apparatus.

32. A structural element in accord with claim 1, therein characterized, ion that the ratio of the length of the shell in the direction to the side structure represents the height of the shell in the travel direction of the panel 15 or less, advantageously, this being 10 or less.

33. An outer shell for a structural element in accord with claim 1.

34. A reinforcement strut for a structural element in accord with claim 1.

35. A panel for a sectional door in accord with claim 1.

36. A sectional door with a sectional panel in accord with claim 35 and a guiding rail installation having two guide rails, situated in parallel next to one another, of which each possesses a straight line section for retaining the sectional door panel in the closed position and a second straight line section for retaining the said sectional door panel in the open position and curved section to connect the said straight line sections together.
